(19) United States
(12) Patent Application Publication
(10) Pub. No.: US 2013/0283961 A1
(43) Pub. Date: Oct. 31, 2013

(54) VEHICLE PEDAL ASSEMBLY WITH TUBULAR PEDAL SHAFT

(71) Applicant: Murray Kaijala, Elkhart, IN (US)

(72) Inventor: Murray Kaijala, Elkhart, IN (US)

(21) Appl. No.: 13/803,356

(22) Filed: Mar. 14, 2013

Related U.S. Application Data
(60) Provisional application No. 61/640,287, filed on Apr. 30, 2012.

(51) Int. Cl. G05G 1/50

(52) U.S. Cl. CPC G05G 1/506
USPC 74/512

(57) ABSTRACT

A vehicle pedal assembly comprising a pedal housing that receives the drum of a pedal arm. An elongate tubular hollow shaft which, in one embodiment, may be made of metal extends through a through-hole defined in the drum and into the side walls of the pedal housing. The pedal shaft may be secured in the pedal housing with lips on the respective side walls that are heat staked against the ends of the pedal shaft. Alternatively, the pedal shaft can include flared distal ends that abut against the exterior surface of the respective side walls, or slots can be formed in the interior surface of the respective side walls of the pedal housing for receiving the respective distal ends of the pedal shaft. The through-hole of the drum and the shaft may include regions of varying diameter.

### CROSS-REFERENCE TO RELATED APPLICATIONS

This application claims the benefit of the filing date and disclosure of U.S. Provisional Application Ser. No. 61/640,287, filed on Apr. 30, 2012 which is explicitly incorporated herein by reference as are all references cited therein.

### FIELD OF THE INVENTION

The invention relates generally to a vehicle pedal assembly and, more specifically, to the shaft which secures the pedal to the housing of the vehicle pedal assembly.

### BACKGROUND OF THE INVENTION

Vehicle pedal assemblies in use today include a pedal coupled for rotation relative to a housing via a shaft that extends through the pedal and into the housing. Currently, the shaft is solid and bearings and/or bushings are used between the shaft and the pedal.

The present invention is directed to a bearingless/bushingless shaft for a vehicle pedal assembly.

### SUMMARY OF THE INVENTION

The present invention is generally directed to a vehicle pedal assembly comprising a pedal housing which includes a base and a pair of spaced-apart side walls which extend upwardly from the base and define a front opening and an interior pedal cavity; a pedal arm which includes a proximal depressible end and a distal opposed end which includes a drum that extends through the front opening and into the interior pedal cavity of the pedal housing, the drum defining an elongate interior through-hole; and an elongate tubular hollow pedal shaft which extends through the through-hole in the drum and into the pedal housing for mounting the pedal in the pedal housing for rotation relative to the shaft and the pedal housing.

In one embodiment, each of the pair of side walls defines a central aperture and a heat stake lip surrounding the central aperture, the pedal shaft includes opposed distal end sections which extend into the central aperture in the respective side walls, and the lip is heat staked into a relationship overlying the opposed distal end sections of the pedal shaft to secure the pedal shaft in the pedal housing.

In one embodiment, each of the side walls of the pedal housing includes an exterior surface and the pedal shaft includes opposed distal flared end sections which abut against the exterior surface of the respective side walls of the pedal housing to secure the pedal shaft in the pedal housing.

In one embodiment, the pedal shaft includes opposed distal end sections and each of the side walls of the pedal housing defines an interior circular slot and the opposed distal end sections of the pedal shaft extend into the slot in the respective side walls of the pedal housing to secure the pedal shaft in the pedal housing.

In one embodiment, the through-hole defined in the drum of the pedal arm includes at least first and second sections of varying diameter and a transition section therebetween, and the pedal shaft includes first and second sections of varying diameter and a transition section therebetween which cooperate with the respective first, second, and transition sections defined by the through-hole in the drum of the pedal arm.

In one embodiment, the pedal shaft is made of stainless steel.

The present invention is also directed to a vehicle pedal assembly comprising a housing which includes a pair of opposed side walls; a pedal which terminates in a distal end extending into the housing, the distal end defining a through-hole; and a shaft which extends in the housing and the through-hole in the drum, the shaft including opposed distal ends which extending and abut against the pair of opposed side walls respectively.

In one embodiment, each of the pair of opposed side walls of the housing defines a through-aperture and includes an exterior surface with an outwardly protruding lip that abuts against each of the respective opposed distal ends of the shaft for securing the shaft in the housing.

In one embodiment, the housing is made of a thermoplastic material and the shaft is made of metal, the lip being heat staked into a relationship abutting against the opposed distal ends of the shaft.

In one embodiment, each of the pair of opposed side walls of the housing includes an exterior surface and defines a through-aperture, the shaft including opposed distal ends with respective flanges that abut against the exterior surface of the respective pair of opposed side walls of the housing for securing the shaft in the housing.

In one embodiment, each of the pair of opposed side walls of the housing includes an interior surface defining a slot, the opposed distal ends of the shaft extending into the slot the pair of opposed side walls respectively for securing the shaft in the housing.

In one embodiment, the through-hole defined in the distal end of the pedal and the shaft include respective regions of varying diameter.

In one embodiment, the through-hole in the distal end of the pedal is defined by an interior surface of the distal end of the pedal, the regions of varying diameter of the through-hole in the distal end of the pedal and the shaft defining a cavity in the distal end of the pedal between the shaft and interior surface of the distal end of the pedal.

In one embodiment, the distal end of the pedal is in the form of a drum.

The present invention is further directed to a vehicle pedal assembly comprising a thermoplastic housing which includes opposed side walls having an exterior surface and defining respective through-apertures; a deformable lip which protrudes from the exterior surface of each of the opposed side walls; a pedal which includes a drum extending into the housing between the opposed side walls of the housing and defining a through-hole; and a metal shaft which extends through the through-hole of the drum and includes opposed distal ends extending through the respective through-apertures in the opposed side walls of the housing, the lip being deformed into a relationship abutting against the opposed distal ends of the metal shaft to secure the shaft in the housing.

There are other advantages and features of this invention which will be more readily apparent from the following detailed description of the embodiment of the invention, the drawings, and the appended claims.

### BRIEF DESCRIPTION OF THE DRAWINGS

In the accompanying drawings that form part of the specification, and in which like numerals are employed to designate like parts throughout the same:

FIG. 1 is a simplified exploded perspective view of one embodiment of a vehicle pedal assembly incorporating a first embodiment of a pedal shaft in accordance with the present invention;

FIG. 2 is an exploded, vertical cross-sectional view of the vehicle pedal assembly shown in FIG. 1;

FIG. 3 is a broken, perspective view of the vehicle pedal assembly shown in FIG. 1;

FIG. 4 is a vertical cross-sectional view of he vehicle pedal assembly shown in FIG. 1;

FIG. 5 is a simplified, exploded perspective view of another embodiment of a vehicle pedal assembly incorporating another embodiment of a pedal shaft in accordance with the present invention;

FIG. 6 is a broken, part perspective view, part vertical cross-sectional view, of the vehicle pedal assembly shown in FIG. 5;

FIG. 7 is a broken, part perspective view, part vertical cross-sectional view, of yet another embodiment of a vehicle pedal assembly incorporating a pedal shaft in accordance with the present invention; and

FIG. 8 is a broken, part perspective view, part vertical cross-sectional view, of yet another embodiment of a vehicle pedal assembly incorporating another embodiment of a pedal shaft in accordance with the present invention.

### DETAILED DESCRIPTION OF THE EMBODIMENTS

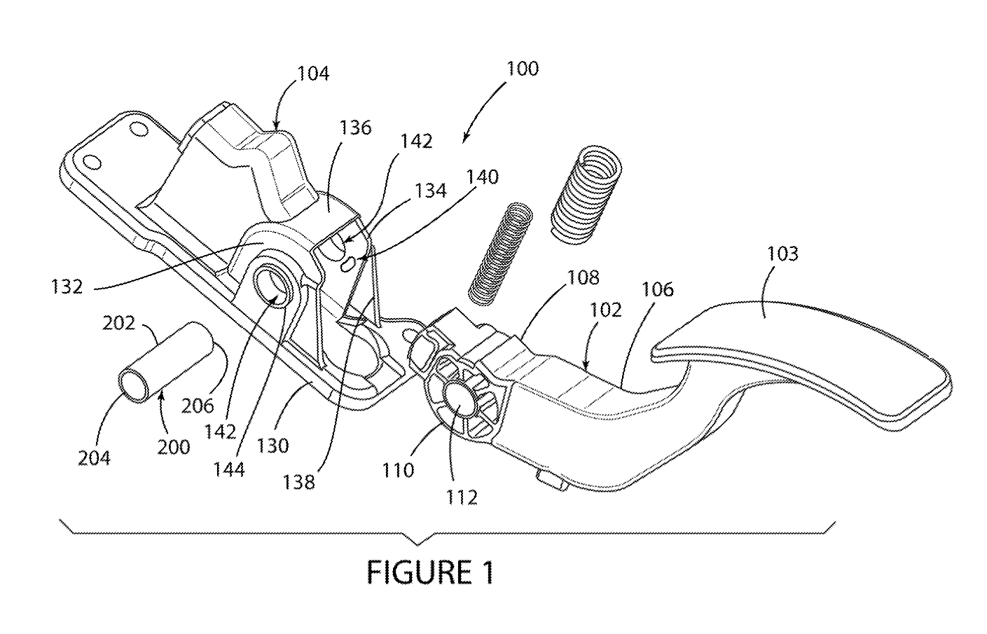

FIGS. 1-4 depict a first embodiment of a vehicle pedal assembly 100 incorporating a pedal shaft 200 in accordance with the present invention.

In the embodiment shown, the vehicle pedal assembly 100 comprises a pedal 102 mounted for rotation within the interior of a pedal housing 104. The pedal 102, which may be made of any suitable thermoplastic material, includes an elongate pedal arm 106 (FIGS. 1 and 3) having a depressible proximal end with a foot plate 103 (FIG. 1) adapted for depression by the foot (not shown) of the operator (not shown) of the vehicle (not shown) and a distal end 108 (FIG. 1) including a drum 110. The drum 110 defines a central and generally cylindrically-shaped through-hole 112 (FIGS. 1, 2, and 4) extending therethrough and terminating in respective generally circular openings in the respective opposed generally vertical side faces of the drum 110.

In the embodiment shown, the pedal housing 104, which may be made of any suitable thermoplastic material, includes a base 130 (FIGS. 1 and 3), a pair of spaced-apart and parallel side walls 132 and 134 extending generally vertically and normally unitarily upwardly from the top surface of the base 130, and a top wall 136 extending between the top peripheral edge of the respective side walls 132 and 134 and together with the side walls 132 and 134 defining an opening 138 (FIG. 1) in the front of the housing 104 and a drum cavity 140 (FIGS. 1, 2, and 4) in the interior of the housing 104.

In the embodiment shown, each of the side walls 132 and 134 of the housing 104 defines a generally circular through-aperture or opening 142 and a circumferentially extending heat stake flange or lip 144 protruding outwardly from the exterior surface of each of the side walls 132 and 134 and surrounding the through-aperture or opening 142 defined in each of the side walls 132 and 134.

In the embodiment shown, the pedal shaft 200 is in the form of an elongate, hollow, generally cylindrically-shaped tube which may be made of any suitable metal material including, for example, stainless steel, plated plain-carbon steel, aluminum, or the like material. The shaft 200 includes a central hollow tubular shaft portion 202 and opposed distal tubular end portions 204 and 206 which, in the embodiment shown, terminate in respective flat radial end faces.

As shown in FIGS. 1, 2, and 3, the pedal 102 is, during the assembly process, coupled to the pedal housing 104 in a relationship wherein the drum 110 of the pedal 102 protrudes through the opening 138 in the front of the housing 104 and into the cavity 140 defined in the interior of the housing 104 and the central through-aperture 112 of the drum 110 is in co-linear alignment with the respective through-aperture 142 defined in each of the side walls 132 and 134 of the housing 104.

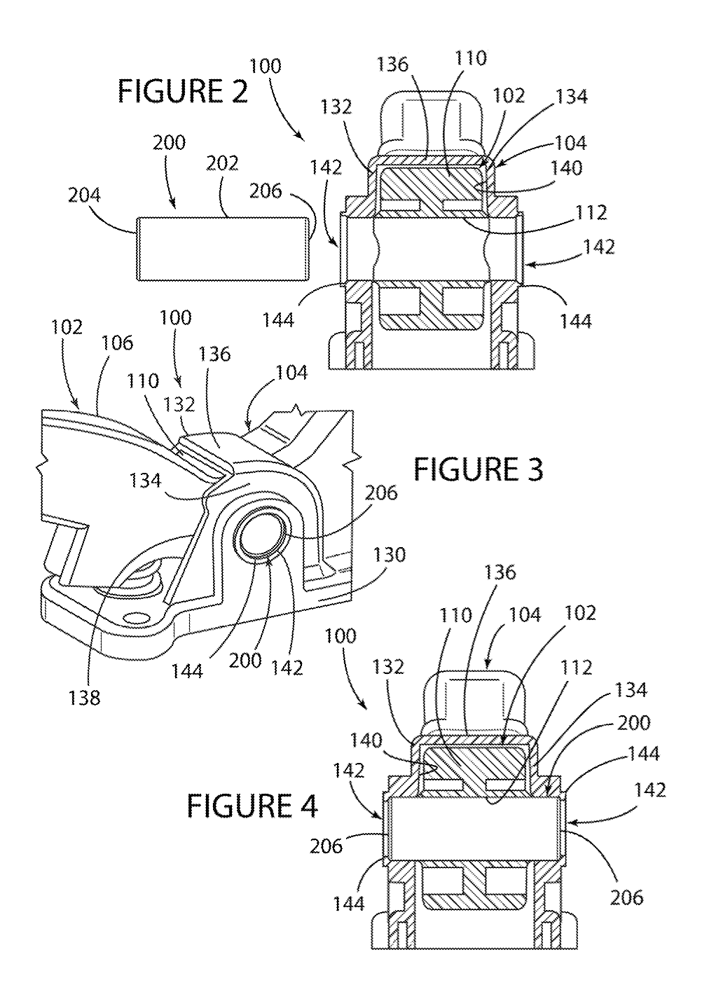

As shown in FIGS. 2 and 3, during the assembly process, the shaft 200 is inserted into the housing 104 through one of the through-apertures into a relationship wherein the central shaft portion 202 of the shaft 200 is positioned in the through-hole 112 in the drum 110 and the opposed distal end portions 204 and 206 of the shaft 200 are seated and abutted against the interior surface of the portion of the respective side walls 132 and 134 defining the respective through-apertures 142 therein.

Thereafter, during the assembly process, and as shown in FIG. 4, the deformable flange or lip 144 defined by the thermoplastic material of the housing 104 on the exterior surface of each of the side walls 132 and 134 of the housing 104 is bent or deformed inwardly via heat staking or the like deformation process into a relationship wherein the flange or lip 144 defined by the thermoplastic material of the housing 104 surrounds, overlies, and abuts against the exterior radial end face of the respective distal end portions 204 and 206 of the pedal shaft 200 to secure the pedal shaft 200 in the pedal 102 and the housing 104.

Moreover, and although not shown in any of the FIGURES, it is understood that the diameter of the drum through-hole 112 is sized relative to the diameter of the pedal shaft 200 to allow for the rotation of the drum 110 and thus the pedal arm 106 relative to the pedal shaft 200 and further that the diameters of the pedal housing side wall openings 138 and the pedal shaft 200 are sized relative to each other to provide a secure press or interference fit between the pedal shaft 200 and the pedal housing 104 to prevent rotation of the pedal shaft 200 relative to the pedal housing 104.

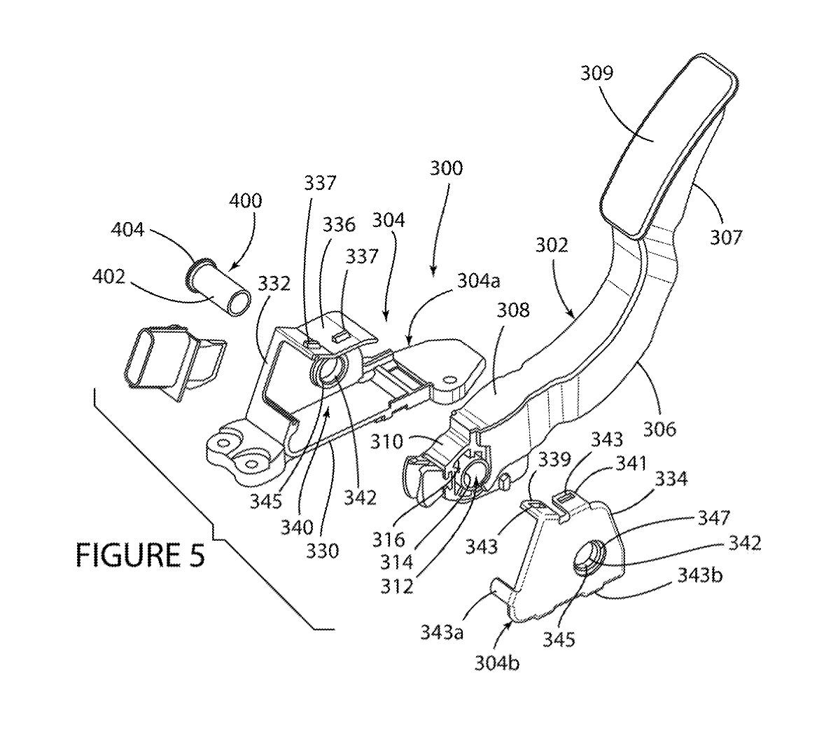

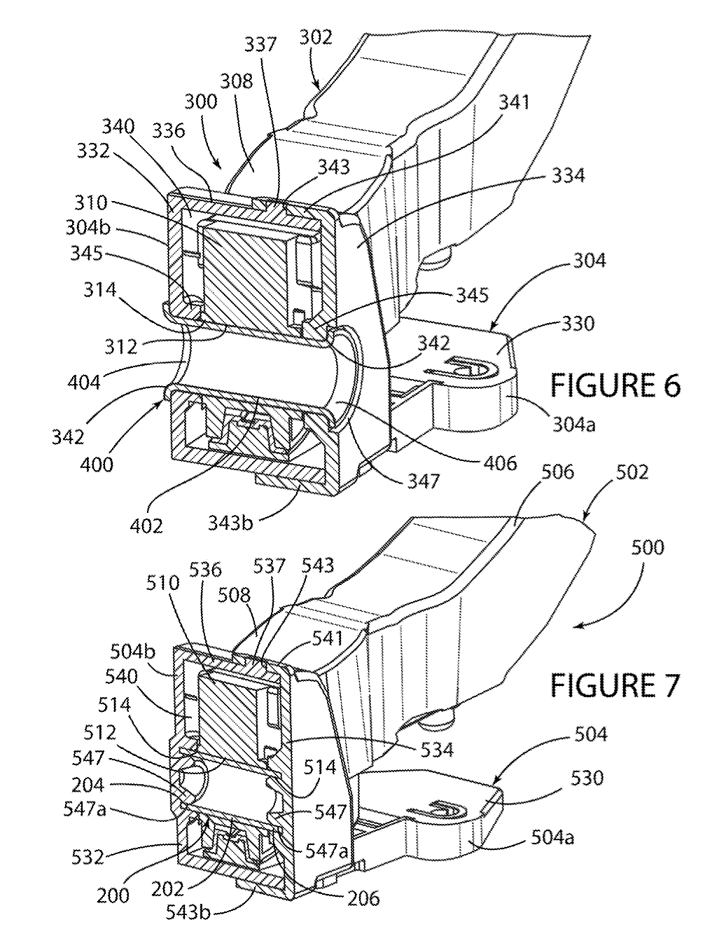

FIGS. 5 and 6 depict another embodiment of a vehicle pedal assembly 300 incorporating another embodiment of a pedal shaft 400 in accordance with the present invention.

In the embodiment shown, the vehicle pedal assembly 300 comprises a pedal 302, which may be made of any suitable thermoplastic material, and is mounted for rotation within the interior of a pedal housing 304. The pedal 302 includes an elongate pedal arm 306 having a proximal end 307 with a foot plate 309 adapted for depression by the foot (not shown) of the operator (not shown) of the vehicle (not shown) and a distal end 308 including a pedal drum 310. The pedal drum 310 defines a central and generally cylindrically-shaped through-hole 312 extending therethrough and terminating in respective generally circular openings 314 in the respective opposed, generally vertical side faces 316 of the drum 310.

The pedal housing 304, which may be made of any suitable thermoplastic material, includes a generally flat, wide, and elongate plate or base 330, a pair of spaced-apart and generally parallel side walls 332 and 334 extending generally vertically upwardly from the base 130, and a top wall 336.

In the embodiment shown, the top wall 336 extends generally normally outwardly from the interior peripheral top edge of the side wall 332 in a relationship spaced from and generally parallel to the base 330 of the pedal housing 304 and the top wall 336 includes a pair of spaced-apart and co-linear tabs 337 protruding generally normally outwardly from the exterior surface thereof.

Moreover, in the embodiment shown, the lower longitudinal peripheral edge of the side wall 332 is unitary with the base 330 and the side peripheral longitudinal edge of the top wall 336 is unitary with the top peripheral longitudinal edge of the side wall 132 to define the first piece or part 304a of a two-part or piece housing 304 and the side wall 334 defines the second part or piece or cover 304b of the two-part or piece housing 304. A pair of spaced-apart clip arms 339 and 341 extends generally normally outwardly from the interior surface of the top peripheral edge of the side wall 334 and an additional pair of spaced-apart clip arms 343a and 343b extend generally normally outwardly from the interior surface of the side and bottom peripheral edges respectively of the side wall 334. Each of the clip arms 339 and 341 define an aperture 343.

Each of the side walls 332 and 334 of the two-part pedal housing 304 additionally defines a through-aperture or opening 342; includes a circumferentially extending flange or lip or collar 345 protruding outwardly from the interior surface of each of the side walls 332 and 334 and surrounding the respective openings 342; and a circumferentially extending shoulder 347 surrounding the respective openings 342 and extending inwardly from the exterior surface of each of the side walls 332 and 334.

In the embodiment shown, the pedal shaft 400 is also in the form of an elongate, hollow, generally cylindrically-shaped tube which may be made of the same type of metal material as the pedal shaft 200. The pedal shaft 400 includes a central hollow tubular shaft portion 402 and opposed distal circumferentially extending outwardly flared flanges or end portions 404 and 406.

As shown in FIGS. 5 and 6, the pedal 302 is, during the assembly process, inserted into the pedal housing 304 in a relationship wherein the drum 310 of the pedal 302 is located in the interior cavity 340 defined in the first housing part 304a of the pedal housing 304 between the base 330 and the top wall 336 with the through-hole 312 of the drum 310 in co-linear alignment with the through-aperture 342 in the side wall 332 of the housing 304.

Thereafter, the cover side wall 334, i.e., the second piece or part 304b of the two-part housing 304, is coupled to the first housing part 304a in a relationship wherein the side wall 334 is positioned opposite, spaced from, and generally parallel to the side wall 332 of the first housing part 304a; the top clip arms 339 and 341 on the housing cover side wall 334 extend over the exterior surface of the top wall 336 of the first housing part 304a and are clipped to the respective tabs 337 on the top exterior surface of the top wall 336 in a relationship wherein the tabs 337 are inserted and secured in the interior of the apertures 343 defined in the clip arms 339 and 341; the other clip arms 343a and 343b on the second housing part 304b extend over the exterior surface of the base 330 of the first housing part 304a; the through-aperture 342 in the cover side wall 334 is in co-linear alignment with the through-hole 312 in the pedal drum 310; and the interior collars 345 of the housing side walls 332 and 334 are abutted against the opposed exterior sides of the pedal drum 310.

Thereafter, during the assembly process, the pedal shaft 400 is inserted into the housing 304 through the through-aperture 342 in the side wall 332 of the first housing part 304a and into the through-hole 312 in the drum 310 and into the through-aperture 342 in the cover side wall 334 and into a relationship wherein the flared distal end portion 404 of the shaft 400 is abutted against the interior shoulder 347 of the side wall 332.

Thereafter, and as shown in FIG. 6, the opposed flared distal end portion 406 is formed on the pedal shaft 400, as for example by bending of the shaft material at the distal end of the shaft during the assembly process and is positioned in a relationship abutting against the interior shoulder 347 in the cover side wall 334 for the purpose of providing structural strength and stiffness to the shaft 400; functioning as a as a tamper-resistant secondary fastener for the cover side wall 334; and keeping the shaft 400 securely connected and stationary in the housing 304.

Thus, and as described above, FIGS. 5, 6, and 7 depict a pedal 300 that includes a metal pedal shaft 400 extending through the pedal drum 310 and cavity 340 of the housing 304 and terminating in opposed distal flanges 404 and 406 abutted against the exterior surfaces or faces of the opposed housing side walls 332 and 334.

Although not shown in any of the FIGURES, it is understood that serrations or the like features designed to prevent the pedal shaft 400 from rotation or movement in the pedal housing 304 may be added to either the pedal housing 304; the pedal shaft 400; and/or one or both of the flared distal ends 404 and 406 of the pedal shaft 400.

Moreover, and although not shown in FIGS. 5 and 6, it is understood that the diameter of the drum through-hole 312 is sized relative to the diameter of the pedal shaft 400 to allow for the rotation of the drum 310 and thus the pedal arm 306 relative to the pedal shaft 400 and further that the diameters of the pedal housing side wall openings 342 and the pedal shaft 400 are sized relative to each other to provide a secure press or interference fit between the pedal shaft 400 and the pedal housing 304 and prevent rotation or movement of the pedal shaft 400 relative to the pedal housing 304.

FIG. 7 depicts yet another embodiment of a vehicle pedal assembly 500 which incorporates the shaft 200 of the present invention as shown in

FIG. 1, and thus the earlier description of the elements or features 202, 204, and 206 of the shaft 200 is incorporated herein by reference.

In the embodiment shown, the vehicle pedal assembly 500 comprises a pedal 502 mounted for rotation in the interior of a pedal housing 504 which, in the embodiment shown, is of the same two-part or two-piece construction as the pedal housing 304, and thus the earlier description of the elements and features thereof is incorporated herein by reference with respect to the FIG. 7 embodiment. The pedal 502 includes an elongate pedal arm 506 (only a portion of which is shown in FIG. 7) having a proximal end (not shown but similar to the proximal end 307 of the pedal arm 306 of the vehicle pedal assembly 300 shown in FIGS. 5 and 6) and a distal end 508 including and terminating in a pedal drum 510. The pedal drum 510 defines a central and generally cylindrically-shaped through-hole 512 extending therethrough and terminating in respective generally circular openings 514 in the respective opposed generally vertical side faces of the pedal drum 510.

The elements 504, 504a, 504b, 530, 532, 534, 536, 540, 541, 543, and 543b identified in FIG. 7 are the same as the corresponding elements 304, 304a, 304b, 330, 332, 334, 336, 340, 341, 343, and 343b described above with respect to the pedal assembly 300, and thus the earlier description of the elements and features thereof is incorporated herein by reference with respect to the pedal assembly 500.

Moreover, and unlike the side walls 332 and 334 of the housing 304 of the pedal assembly 300, the interior surface of each of the side walls 532 and 534 of the housing 504 of the pedal assembly 500 additionally includes an outwardly extending collar 547 defining an interior generally circumferentially extending circular slot or groove 547a.

Although not shown or described herein in any detail, it is understood that during the assembly process, the pedal 502 is inserted into the pedal housing 504 in a relationship and into a position wherein the drum 510 of the pedal 502 is located in the interior cavity 540 of the housing 504 between the base 530 and the top wall 536 with the peripheral circumferential surface of the drum 510 defining the through-hole 512 therein in co-linear alignment with the circular slot/groove 547 defined in the interior surface of the side wall 532 of the housing 504.

Thereafter, during the assembly process, the shaft 200 is inserted into and through the through-hole 512 of the drum 510 into the relationship and position as shown in FIG. 7 wherein the distal end portion 204 of the shaft 200 is located in the interior of the slot/groove 547 defined in the side wall 532 of the pedal housing 504 and abutted against the interior surface of the side wall 532; and the central portion 202 of the pedal shaft 200 is located in and extends through the through-hole 512 defined in the drum 510.

Thereafter, during the assembly process, the cover side wall 534 is secured to the housing 504 in the same manner as described above with respect to the cover side wall 334 of the vehicle pedal assembly 300, and thus the earlier description of the features and method is incorporated herein by reference with respect to the cover side wall 534, into the relationship and position as shown in

FIG. 7 wherein the opposed distal end 206 of the pedal shaft 200 is received and extends into the circular slot/groove 547 defined in the interior surface of the cover side wall 534 of the pedal housing 504 to secure the pedal shaft 200 in the pedal housing 504.

Thus, in the embodiment shown, the pedal assembly 500 includes a pair of housing side walls 532 and 534, each including an interior surface defining a slot or groove 547 that seats, receives, and secures the respective distal ends 204 and 206 of a hollow tubular metal shaft 200 that extends in the housing 504 through the drum 510 of the pedal 502.

Moreover, and although not shown in FIG. 7, it is understood that the diameter of the drum through-hole 512 is sized relative to the diameter of the pedal shaft 200 to allow for the rotation of the drum 510 and thus the pedal arm 506 relative to the pedal shaft 200 and further that the relationship between the thickness or width of the slots or grooves 547 in the housing side walls 532 and 534 and the thickness or width of the tube defining the pedal shaft 200 is such as to provide a secure press or interference fit between the pedal shaft 200 and the pedal housing 504 that prevents rotation and movement of the pedal shaft 200 relative to the pedal housing 504.

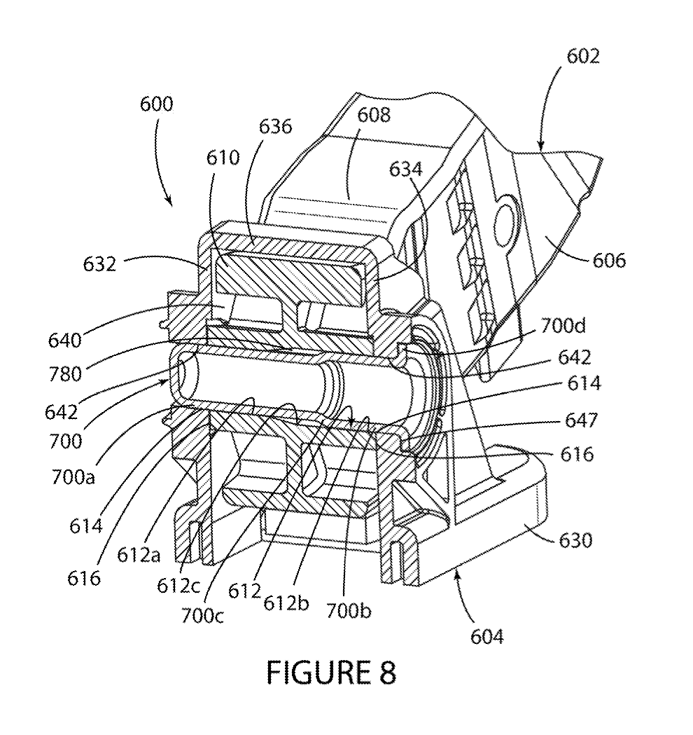

FIG. 8 depicts yet another embodiment of a vehicle pedal assembly 600 which incorporates another embodiment of a pedal shaft 700 in accordance with the present invention.

In the embodiment shown, the vehicle pedal assembly 600 comprises a pedal 602 mounted for rotation with the interior of a pedal housing 604. The pedal 602 includes an elongate pedal arm 606 (only a portion of which is shown in FIG. 8) having a proximal end (not shown but similar to the proximal end 307 of the pedal arm 306 of the vehicle pedal assembly 300 shown in FIGS. 5 and 6) and a distal end 608 including a pedal drum 610. The pedal drum 610 defines a central and generally cylindrically-shaped through-hole 612 extending therethrough and terminating in respective generally circular openings 614 in the respective opposed generally vertical side faces 616 of the pedal drum 610.

The pedal drum 610 differs however from the pedal drums of the pedal arms depicted in the earlier FIGS. 1-7 pedal assembly embodiments in that the through-hole 612 of the pedal drum 610 and thus the interior surface of the pedal drum 610 defining the through-hole 612 includes a first end section 612a having a first diameter, an opposed second end section 612b having a second diameter greater than the diameter of the first end section 612a, and a center transition or flared or sloped or angled section 612c located between and interconnecting the first and second end sections 612a and 612b.

The pedal housing 604 includes a base 630, a pair of spaced-apart and generally parallel side walls 632 and 634 extending generally vertically unitarily upwardly from the base 630, and a top wall 636 extending between the top peripheral edge of the respective housing side walls 632 and 634 and together with the housing side walls 632 and 634 define an opening (not shown) in the front of the pedal housing 604 and a cavity 640 in the interior of the pedal housing 604.

Each of the side walls 632 and 634 of the pedal housing 604 defines a generally circular through-aperture or opening 642 and, in the embodiment shown, the side wall 634 defines an interior circumferentially extending shoulder 647 which extends inwardly into the side wall 634 from the exterior surface thereof and surrounds the through-aperture or opening 642 defined therein.

In the embodiment shown, the pedal shaft 700 is in the form of an elongate, hollow, generally cylindrically-shaped tube which may be made of the same type of metal material as the shaft 200. The shaft 700, differs from the shaft 200 described earlier in that the shaft 700 is a deep-drawn part including a first end section or region 700a having a first diameter, a second opposed end section or region 700b having a diameter greater than the first end section or region 700a and terminating in an upwardly and outwardly flared distal peripheral end face or flange 700d, and a center sloped or angled or flared transition section or region 700c located between and interconnecting the first and second end sections or regions 700a and 700b.

The pedal 602 is, during the assembly process, inserted into the pedal housing 604 into a relationship wherein the drum 610 of the pedal 602 is located in the interior cavity 640 of the pedal housing 604 between the base 630 and the top wall 636 with the through-hole 612 of the drum 610 in co-linear alignment with the through-apertures 642 in the side walls 632 and 634 of the pedal housing 604.

Thereafter, the pedal shaft 700 is inserted through the through-aperture 642 in the side wall 634 and the through-hole 612 in the drum 610 and into the through-aperture 342 in the opposed side wall 632 and into a relationship wherein the flared distal end portion or flange 700d of the shaft 700 is abutted against the interior shoulder 647 of the side wall 634.

As shown in FIG. 8, the use of a drum through-hole 612 and pedal shaft 700 having sections or regions thereof with different diameters creates and defines a vehicle pedal assembly 600 with two separate shaft/drum bearing diameters which provide an advantage for tuning in the fit and roundness of the pedal arm 606.

Moreover, and although not shown in FIG. 8, it is understood that the diameter of the drum through-hole sections 612a, 61 2b, and 612c are sized relative to the diameter of the respective cooperating and opposed pedal shaft sections 700a, 700b, and 700c to allow for the rotation of the drum 610 and thus the pedal arm 606 relative to the pedal shaft 700 and also to define an interior debris cavity or receptacle or space or gap 780 between the exterior surface of the shaft 700 and the interior surface of the drum 612 in the region of the respective opposed pedal shaft and drum through-hole sections 700c and 612c.

Further, and although not shown in FIG. 8, it is also understood that the diameters of the pedal housing side wall openings 642 and the pedal shaft 700 and, more specifically, the shaft sections 700a and 700b thereof which are of varying diameter, are sized relative to each other to provide a secure press or interference fit between the pedal shaft 700 and the pedal housing 704 which prevents rotation of the pedal shaft 700 relative to the pedal housing 704.

Numerous variations and modifications of the embodiments described above may be effected without departing from the spirit and scope of the novel features of the invention. It is thus understood that no limitations with respect to the pedal shafts or the vehicle pedal assemblies illustrated herein are intended or should be inferred. It is, of course, intended to cover by the appended claims all such modifications as fall within the scope of the claims.

I claim:

1. A vehicle pedal assembly comprising:
a pedal housing including a base and a pair of spaced-apart side walls extending upwardly from the base and defining a front opening and an interior pedal cavity;
a pedal arm including a proximal depressable end and a distal opposed end including a drum extending through the front opening and into the interior pedal cavity of the pedal housing, the drum defining an elongated interior through-hole; and
an elongated tubular hollow pedal shaft extending through the through-hole in the drum and into the pedal housing for mounting the pedal in the pedal housing for rotation relative to the shaft and the pedal housing.

2. The vehicle pedal assembly of claim 1 wherein each of the pair of side walls defines a central aperture and a heat stake lip surrounding the central aperture, the pedal shaft including opposed distal end sections extending into the central aperture in the respective side walls and the lip is heat staked into a relationship overlying the opposed distal end sections of the pedal shaft for securing the pedal shaft in the pedal housing.

3. The vehicle pedal assembly of claim 1 wherein each of the side walls of the pedal housing includes an exterior surface and the pedal shaft includes opposed distal flared end sections abutting against the exterior surface of the respective side walls of the pedal housing for securing the pedal shaft in the pedal housing.

4. The vehicle pedal assembly of claim 1 wherein the pedal shaft includes opposed distal end sections, each of the side walls of the pedal housing defining an interior circular slot and the opposed distal end sections of the pedal shaft extending into the slot in the respective side walls of the pedal housing for securing the pedal shaft in the pedal housing.

5. The vehicle pedal assembly of claim 1 wherein the through-hole defined in the drum of the pedal arm includes at least first and second sections of varying diameter and a transition section therebetween, and the pedal shaft includes first and second sections of varying diameter and a transition section therebetween which cooperate with the respective first, second, and transition sections defined by the through-hole in the drum of the pedal arm.

6. The vehicle pedal assembly of claim 1 wherein the pedal shaft is made of a metallic material.

7. A vehicle pedal assembly comprising;
a housing including a pair of opposed side walls;
a pedal terminating in a distal end extending into the housing, the distal end defining a through-hole; and
a shaft extending in the housing and the through-hole in the drum, the shaft including opposed distal ends extending and abutted against the pair of opposed side walls respectively.

8. The vehicle pedal assembly of claim 7 wherein each of the pair of opposed side walls of the housing defines a through-aperture and includes an exterior surface with an outwardly protruding lip that abuts against each of the respective opposed distal ends of the shaft for securing the shaft in the housing.

9. The vehicle pedal assembly of claim 8 wherein the housing is made of a thermoplastic material and the shaft is made of metal, the lip being heat staked into a relationship abutting against the opposed distal ends of the shaft.

10. The vehicle pedal assembly of claim 7 wherein each of the pair of opposed side walls of the housing includes an exterior surface and defines a through-aperture, the shaft including opposed distal ends with respective flanges that abut against the exterior surface of the respective pair of opposed side walls of the housing for securing the shaft in the housing.

11. The vehicle pedal assembly of claim 7 wherein each of the pair of opposed side walls of the housing includes an interior surface defining a slot, the opposed distal ends of the shaft extending into the slot the pair of opposed side walls respectively for securing the shaft in the housing.

12. The vehicle pedal assembly of claim 7 wherein the through-hole defined in the distal end of the pedal and the shaft include respective regions of varying diameter.

13. The vehicle pedal assembly of claim 12 wherein the through-hole in the distal end of the pedal is defined by an interior surface of the distal end of the pedal, the regions of varying diameter of the through-hole in the distal end of the pedal and the shaft defining a cavity in the distal end of the pedal between the shaft and interior surface of the distal end of the pedal.

14. The vehicle pedal assembly of claim 12 wherein the distal end of the pedal is in the form of a drum.

15. A vehicle pedal assembly comprising:
a thermoplastic housing including opposed side walls having an exterior surface and defining respective through-apertures;
a deformable lip protruding from the exterior surface of each of the opposed side walls;
a pedal including a drum extending into the housing between the opposed side wails of the housing and defining a through-hole; and
a metal shaft extending through the through-hole of the drum and including opposed distal ends extending through the respective through-apertures in the opposed side walls of the housing, the lip being deformed into a relationship abutting against the opposed distal ends of the metal shaft to secure the shaft in the housing.
